(19) United States
(12) Patent Application Publication
(10) Pub. No.: US 2008/0256781 A1
(43) Pub. Date: Oct. 23, 2008

(54) Joining method and joined unit

(75) Inventors: Kazuhiro Murakami, Susono (JP); Yoshihiko Watanabe, Susono (JP); Kazuhide Takahashi, Kosai (JP); Kimitoshi Makino, Kosai (JP)

Correspondence Address: Edwards Angell Palmer & Dodge LLP, P.O. Box 55874, Boston, MA, 02205, US

(73) Assignee: Yazaki Corporation, Tokyo (JP)

(21) Appl. No.: 12/081,494

(22) Filed: Apr. 16, 2008

(30) Foreign Application Priority Data
Apr. 19, 2007 (JP) 2007-111024

(51) Int. Cl. B21D 39/00; B23Q 1/00

(52) U.S. Cl. 29/524.1; 29/283.5

(57) ABSTRACT

The present invention provides a joining method of metal plates, which can connect two metal plates without a projection in a surface of the metal plates and a gap, and a joined unit having metal plates which are connected without a projection in a surface of the metal plates and a gap between the metal plates. The joined unit has a pair of metal plates. One of the metal plates has a hole, and another metal plate has a projection having a height less than a thickness of the one of the metal plates. The projection passes through the hole, the one of the metal plates is placed on the other of the metal plates each other, and a central part of an end surface of the projection is crushed in the hole. Thereby, the metal plates are joined to each other, and the joined unit can be provided.

The priority application Number Japan Patent Application No. 2007-111024 upon which this patent application is based is hereby incorporated by reference.

### BACKGROUND OF THE INVENTION

1. Field of the Invention

The present invention relates to a joining method which joins a pair of metal plates, and a joined unit having a pair of metal plates joined each other.

2. Description of the Related Art

Generally, various electronic devices, for example a light such as headlights and a rear light, and a motor such as a starter motor and a motor for air condition, are mounted in a vehicle as a mobile object.

A wiring harness and an electronic connection box are arranged in the vehicle so as to provide electrical power into the above mentioned various electronic devices. The wiring harness, of course, includes multiple electrical wires and a connector. The connector has a terminal made of conductive plate and a connector housing made of an insulation synthetic resin. The connector housing receives the terminal. The connector is connected to various electronic devices.

The electronic connection box has a box body made of an insulation synthetic resin and a wiring board received in the box body. Various electrical parts, for example a relay and a fuse, and a connector of wiring harness are mounted on the box body.

The wiring board has a plurality of conductive bus bars (correspond to metal plates), and an insulating plate which insulates each bus bars electrically. The bus bar is made by punching and bending in a conductive plate. The insulating plate is made of insulation synthetic resin, and is formed into a plane shape.

The wiring board, that is the electronic connection box, electrically connects the various electrical parts such as a relay and a fuse and the electrical wire of wiring harness with a predetermined pattern. Thereafter, the electronic connection box divides electric power provided from a power source in various electronic devices.

### SUMMARY OF THE INVENTION

### Objects to be Solved

The above mentioned bus bars are made by punching and bending in a thick plate. When the bus bars are connected each other, heretofore various welding methods are used. However, when the bus bars are connected each other by welding, a solder used in this welding is formed to a projecting shape. As a result, it is hard to set the bus bars in an insulating plate when the bus bars are assembled in a wiring board. In this case, the bus bars can not be positioned in the insulating plate. Thereby, it is difficult to connect electrically the above electrical parts and the above electrical wire of the wiring harness with a predetermined pattern.

On the other hand, the bus bars can be connected by caulking. In this case, it is difficult to connect electrically fully each bus bar so that a gap is formed to a connection part of the bus bars. Furthermore, after long time advances, the bus bars corrode from the above mentioned gap by moisture in the air. Thereby, electronic resistance between the bus bars increases.

Therefore, an object of the present invention is to provide a joining method of metal plates, which can connect two metal plates without a projection in a surface of the metal plates and a gap, and a joined unit having metal plates which can be connected without a projection in a surface of the metal plates and a gap.

### How to Attain the Object of the Present Invention

According to a first aspect of the present invention, a joining method of a pair of metal plates includes the steps of: providing one of the pair of the metal plates (herein after, one metal plate) with a hole, providing another of the pair of the metal plates (herein after, the other metal plate) with a projection having a height less than a thickness of the one metal plate, letting the projection pass through the hole, placing the one metal plate on the other metal plate, and crushing a central part of an end surface of the projection. Thereby, the metal plates are joined to each other.

According to a second aspect of the present invention, as mentioned above, the crushing is carried out on a condition that a tapered protrusion 12 is pressed onto the central part of the end surface 5a of the projection 5.

According to a third aspect of the present invention, a joined unit has a pair of metal plates which are joined each other. The one metal plate includes a hole, and the other metal plate includes a projection. The height of the projection is less than a thickness of one metal plate. The projection is let pass through the hole, and the one metal plate is placed on the other metal plate. Thereafter, a central part of an end surface of the projection is crushed in the hole, and an outer peripheral surface of the projection adheres to an inner peripheral surface of the hole.

### Effect of the Invention

According to the invention, the projection provided on the other metal plate is inserted into a hole provided in the one metal plate. Thereby, the central part of the end surface of the projection is crushed. A height of the projection is formed smaller than a thickness of the one metal plate. Therefore, the projection in which the central part of the end surface is crushed becomes deformed to an expanded shape in the hole. Thereby, the outer peripheral surface of the projection adheres to the inner peripheral surface. Also, a projection is not produced in a surface of the metal plates so that the projection provided on the other metal plate is enlarged in the hole.

Therefore, the metal plates can be connected without the projection of the surface of the metal plate. Consequently, when the metal plates are used as a bus bar of wiring board of electronic connection box, the metal plates can be located certainly at an insulating plate. Furthermore, it is possible to provide a joined unit which can connect electrical parts mounted on the electronic connection box and electrical wire of wiring harness with a predetermined pattern.

In addition, the joined unit can be prevented from a corrosion of the connection part of the metal plates so that a gap is not produced. Thereby, the electronic resistance between the bus bars does not increase as long time advances.

According to the invention, a tapered protrusion is pressed to the central part of the end surface of the projection. Thereafter, the central part of the projection of the other metal plate is crushed by the tapered protrusion. Thereby, the outer peripheral surface of the projection adheres certainly to the inner peripheral surface of the hole so that the projection is spread.

The above and other objects and features of this invention will become more apparent from the following description taken in conjunction with the accompanying drawings.

### BRIEF DESCRIPTION OF THE DRAWINGS

FIG. 1 is a perspective view of an embodiment of a joined unit of the present invention;

FIG. 2 is an exploded perspective view of the joined unit of FIG. 1;

FIG. 3 is a sectional view taken along the line III-III in FIG. 1;

FIG. 4 is a sectional view taken along the line IV-IV in FIG. 2;

FIG. 5 is a sectional view taken along the line V-V in FIG. 2;

FIG. 6 is a sectional view of metal plates of the joined unit of FIG. 1 placing each other;

FIG. 7 is a sectional view of pressing a protrusion of a die into a central part of end surface of the projection of the joined unit of FIG. 6;

FIG. 8 is a sectional view showing that the central part of the end surface of the projection of the joined unit of FIG. 6 is crushed; and

FIG. 9 is a sectional SIM image of joined unit of FIG. 3.

### DESCRIPTION OF THE PREFERRED EMBODIMENT

A joining method and a joined unit according to one embodiment of the present invention are explained by referring to in FIGS. 1-9.

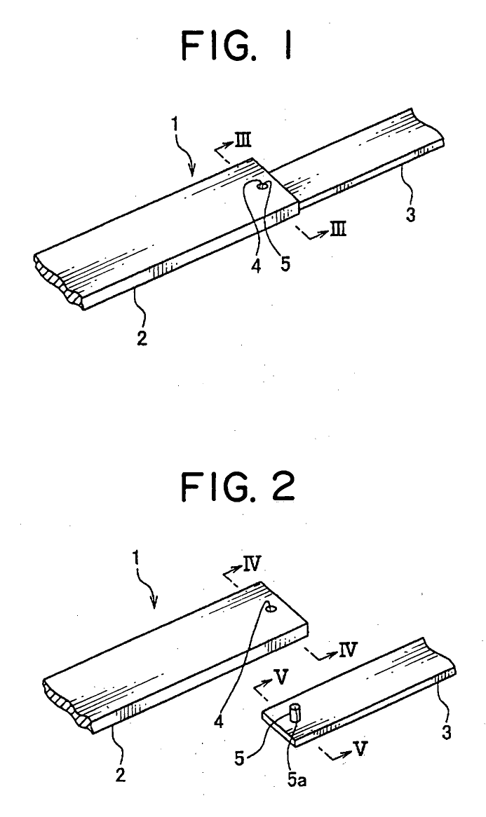

As shown in FIGS. 1 and 2, a joined unit 1 in the embodiments has a pair of metal plates 2 and 3 joined each other. The metal plates 2 and 3 are formed into a plane shape of constant thickness.

The metal plate 2 shown in FIGS. 1 and 2 has a hole 4 passing through the metal plate 2 as shown in FIG. 4. A planar shape of the hole 4 is round.

The other metal plate 3 shown in FIGS. 1 and 2 has a projection 5 which is projected from a surface of the other metal plate 2 as shown in FIG. 5. The projection 5 is formed into a circular cylinder shape before a central part of an end surface 5a in the projection is crushed. An outer diameter of the projection 5 is slightly smaller than an inner diameter of the hole 4. For this reason, the projection 5 is able to passes through the hole 4. Also, a height D from a surface of the other metal plate to the end surface of the projection 5 is formed lower than a thickness T of the above mentioned one metal plate 2. That is, the projection 5 is formed less than the thickness T of the one metal plate 2. Consequently, when the projection 5 passes through the hole 4, the whole of the projection 5 is received in the hole 4.

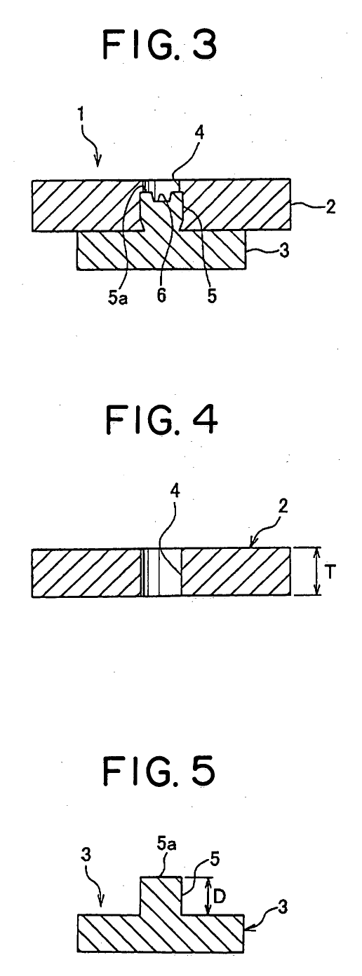

As shown in FIG. 3, the projection 5 passes through the hole 4 in the joined unit 1, and the metal plates 2 and 3 are placed on each other. Furthermore, the central part of the end surface 5a being away from the surface of the other metal plate 3 is crushed toward the other metal plate 3. Thereby, an outer peripheral surface of the projection 5 and an inner peripheral surface of the hole 4 adhere each other (those are attached by each intermolecular force), and the pair of the metal plates 2 and 3 are joined to each other. Therefore, a dent 6 is formed to the central part of the end surface 5a of the projection 5 in the joined unit 1.

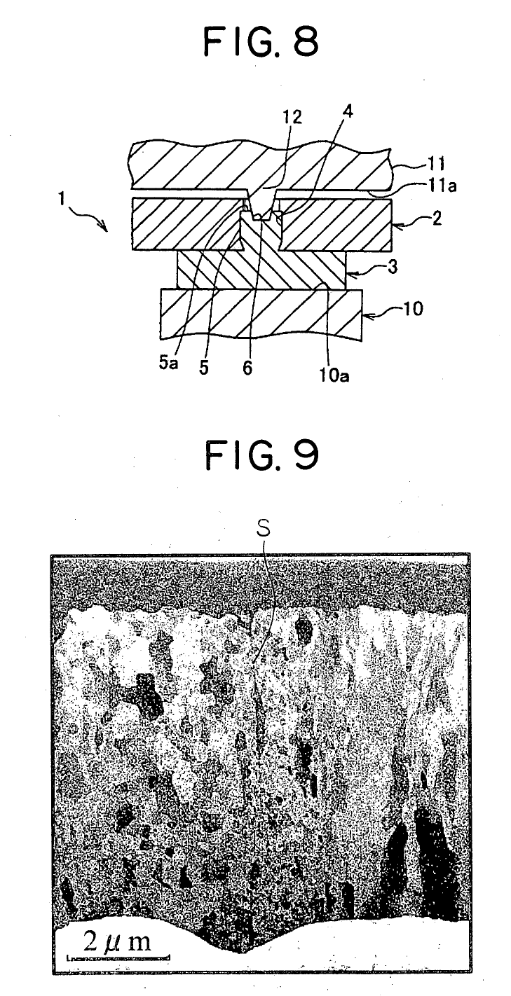

The above mentioned joined unit is produced by joining the metal plates 2 and 3. The metal plates 2 and 3 are joined by a pair of dies 10 and 11 which can approach or depart from each other (shown in FIGS. 7 and 8). The die 10 has an upper surface 10a as shown in FIGS. 7 and 8. The upper surface 10a is formed into flat. The other die 11 has a lower surface 11a and a protrusion 12 as shown in FIGS. 7 and 8. The lower surface 11a is formed into flat, and the protrusion 12 is provided to the lower surface 11a. The protrusion 12 is formed into a circular cone shape in order to taper it gradually from the lower surface 11a. That is, the protrusion 12 is formed into a tapered shape from the lower surface 11a. An end surface of the protrusion 12 is formed in parallel to the lower surface 11a.

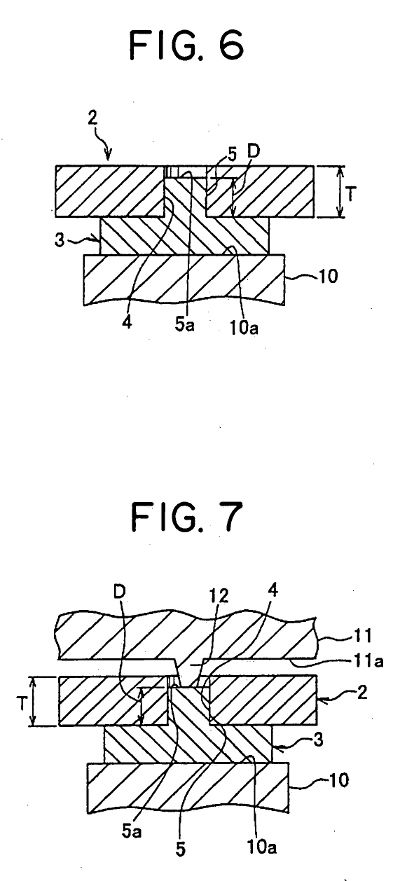

When the above mentioned metal plates 2 and 3 are joined, as shown in FIG. 6, the projection 5 passes through the hole 4 and the metal plate 2 is placed on the other metal plate 3 each other. Furthermore, the other metal plate 3 is overlapped with the upper surface 10a of the metal plate 10. As a result, the projection 5 is received in the hole 4. And then, the other die 11 is approached to the die 10. As shown in FIG. 7, the protrusion 12 provided on the other die 11 is pressed to the central part of the end surface 5a of the projection 5. Thereafter, the pair of metal plates 10 and 11 is approached to each other, and the central part of the end surface 5a of the projection 5 is crushed by the protrusion 12. Thereby, as shown in FIG. 8, as the protrusion 12 crushes the central part of the end surface 5a of the projection 5, the outer peripheral surface of the protrusion 12 presses a member of projection 5 toward the inner peripheral surface of hole 4. And then, the projection 5 causes a plastic deformation like the projection 5 is spread in the hole 4. Thereby, the outer peripheral surface of the projection 5 adheres tightly to the inner peripheral surface of the hole 4 each other. Therefore, the joined unit 1 is made of the above mentioned component in which the outer peripheral surface of the projection 5 and the inner peripheral surface of the hole 4 adhere to each other.

According to embodiments, the central part of the end surface 5a of the projection 5 is crushed by inserting the projection 5 formed on the other metal plate 3 into the hole 4 provided in the metal plate 2. In addition, the height of the projection 5 is formed less than the thickness T of the metal plate 2. Thereby, the projection 5 in which the central part of end surface 5a was crushed is expanded in the hole 4, and the outer peripheral surface of the projection 5 adheres to the inner peripheral surface of the hole 4. Furthermore, the projection 5 does not project from a surface of metal plates 2 so that the projection 5 enlarges in the hole 4.

Now therefore, surfaces of metal plates 2 and 3 can maintain a flat, and the metal plates 2 and 3 can be connected without a gap. Also, when the metal plates are used as a bus bar of a wiring board of an electronic connection box, the metal plates can be located certainly at an insulating plate. Furthermore, it is possible to make the joined unit which can steadily connect electrical parts mounted on the electronic connection box and electrical wires of wiring harness with a predetermined pattern.

Additionally, in the joined unit, since a gap is not produced between the metal plates 2 and 3, a corrosion which is caused to a connection part of the metal plates 2 and 3 can be prevented. Also, electronic resistance between the metal plates 2 and 3 does not increase as long time advances.

Moreover, since the tapered protrusion 12 is pressed to the central part of the end surface 5a of the projection 5, the central part of the end surface 5a of the projection 5 is crushed by the protrusion 12. Thereby, the projection 5 is pushed and expanded in the hole 4 by an outer peripheral surface of the protrusion 12. Accordingly, the outer peripheral surface of the projection 5 and the inner peripheral surface of the hole 4 adhere closely.

The inventors actually manufactured the above mentioned joined unit 1. The metal plate 2 of the joined unit 1 is made of copper alloy, and a thickness T of the metal plate 2 is 0.64 mm. On the other hand, the other metal plate 3 of the joined unit 1 is made of pure copper, and the thickness T of metal plate 3 is 0.64 mm. Those metal plates 2 and 3 are joined. FIG. 9 is a SIM (Scanning Ion Microscopy) image of cross section including a border S between the outer peripheral surface of the projection 5 and the inner peripheral surface of the hole 4. (The SIM image can be given by detecting secondary electron emitted after scanning the above cross section by Ga ion beam) As shown in FIG. 9, it is apparent that the outer peripheral surface of the projection 5 adheres to the inner peripheral surface of the hole 4 in the border S. Therefore, by crushing the central part of the end surface 5a of the projection 5 which is received in the hole 4, it is found that the inner peripheral surface of the hole 4 adheres to the outer peripheral surface of the projection 5.

The metal plates 2 and 3 are made of single metal in which an outer peripheral surface is not plated in the above mentioned embodiments. However, in the present invention, it is appreciated that coating the outer peripheral surface of the metal plates 2 and 3 are adapted.

The embodiments of the present invention are only exemplary and not limited thereto. Any modification and alteration are within the scope of the present invention.

What is claimed is:

1. A joining method of a pair of metal plates comprising the steps of:
providing one of the pair of the metal plates with a hole,
providing another of the pair of the metal plates with a projection having a height less than a thickness of the one of the pair of the metal plates,
letting the projection pass through the hole,
placing the one of the pair of the metal plates on the another of the pair of the metal plate; and
crushing a central part of an end surface of the projection.

2. The joining method as claimed in claim 1, wherein the crushing is carried out on a condition that a tapered protrusion is pressed onto the central part of the end surface of the projection.

3. A joining unit including a pair of metal plates joined to each other comprising:
a hole provided in one of the pair of the metal plates; and
a projection formed on another of the pair of the metal plates, a height of the projection being less than a thickness of the one of the pair of the metal plates,
wherein the projection is let pass through the hole, the one of the pair of the metal plates is placed on the another of the pair of the metal plates, a central part of an end surface of the projection is crushed in the hole, and an outer peripheral surface of the projection adheres on an inner peripheral surface of the hole.
